(19) United States
(12) Patent Application Publication
(10) Pub. No.: US 2021/0272242 A1
(43) Pub. Date: Sep. 2, 2021

(54) METHOD AND APPARATUS FOR USE WITH A SCANNING APPARATUS

(71) Applicant: OXFORD UNIVERSITY INNOVATION LIMITED, Oxford (GB)

(72) Inventors: Bartlomiej W. PAPIEZ, Oxford (GB); Bostjan MARKELC, Ljubljana (SI); Graham BROWN, Oxon (GB); Ruth J. MUSCHEL, Oxford (GB); John Michael BRADY, Headington, Oxford (GB); Julia Anne SCHNABEL, London (GB)

(73) Assignee: Oxford University Innovation Limited, Oxford (GB)

(21) Appl. No.: 17/053,958

(22) PCT Filed: May 10, 2019
(86) PCT No.: PCT/GB2019/051291

§ 371 Date: Nov. 9, 2020

(30) Foreign Application Priority Data
May 10, 2018 (GB) 1807598.6

(51) Int. Cl. G06T 5/00; G06T 5/50

(52) U.S. Cl. CPC G06T 5/002; G06T 2207/10056; G06T 2207/20021; G06T 5/50

(57) ABSTRACT

Embodiments of the present invention provide a computer-implemented method of determining displacement information, comprising receiving (520) image data (485) comprising first pixel data (610) corresponding to movement of a scanning apparatus (130), with respect to at least one object, in a first direction and a second pixel data (620) corresponding to movement of the scanning apparatus (130) in a second direction, and determining (520) displacement information indicative of a displacement of at least a portion of the second pixel data (620) with respect to the first pixel data (610) by minimising a cost function indicative of a similarity between the first and second pixel data.

### BACKGROUND

In many sensing and measurement applications a scanning apparatus is scanned across a scene which comprises one or more objects. The scanning apparatus may emit radiation toward the one or more objects. One or more detectors, which may be part of the scanning apparatus, detect a response of the one or more objects to the emitted radiation. The response of the one or more objects may comprise reflection of radiation or absorbance and re-emission of received radiation. Data determined in dependence on the detector output is stored as pixel values wherein each pixel corresponds to a respective location within the scene.

Laser scanning apparatus are an example of such scanning apparatus. Examples of laser scanning apparatus are laser scanning microscopy (LSM) and LIDAR. In such laser scanning a radiation in the form of light is directed by the scanning apparatus to a specific point within the scene. In the case of LSM the point may be a location upon an object being imaged. In the case of LIDAR the point is within the scene for which it is desired to determine a distance, such as with respect to a vehicle on which the LIDAR is mounted. A response of the detector at the specific point is stored, for example in a memory, as a pixel value. The scanning apparatus scans the point at which radiation is directed across the scene to determine pixel values throughout the scene, as will be appreciated. The scanning across the scene is performed according to a predetermined pattern which may comprise one or more scanning paths when the scanning apparatus emits radiation, often in the form of lines. Pixel values are determined along the scanning paths and may be used, for example although not exclusively, to form an image of the scene. However, artefacts may occur due to errors or inaccuracies in movement of the scanning apparatus. An example of such an artefact is jaggedness caused by inaccuracy in movement of the scanning apparatus. Jaggedness may be exhibited as differing horizontal displacement of lines of pixel values. A further example artefact may be unequal vertical spacing between scan lines caused by rapid movement (fly-back) of the scanning apparatus from an end of one scan line to a beginning of a next scan line.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 illustrates an apparatus according to an embodiment of the invention;

FIG. 2 illustrates unidirectional and bidirectional scanning of a scanning device;

FIG. 3 shows example artefacts in image data;

FIG. 4 shows a schematic illustration of an apparatus according to an embodiment of the invention;

FIG. 5 shows a method according to an embodiment of the invention; and

FIG. 6 illustrates pixel displacement;

FIG. 7 illustrates displacement against pixel position;

FIG. 8 is a further illustration of displacement against pixel position; and

FIG. 9 is images produced by a scanning apparatus.

### DETAILED DESCRIPTION OF EMBODIMENTS OF THE INVENTION

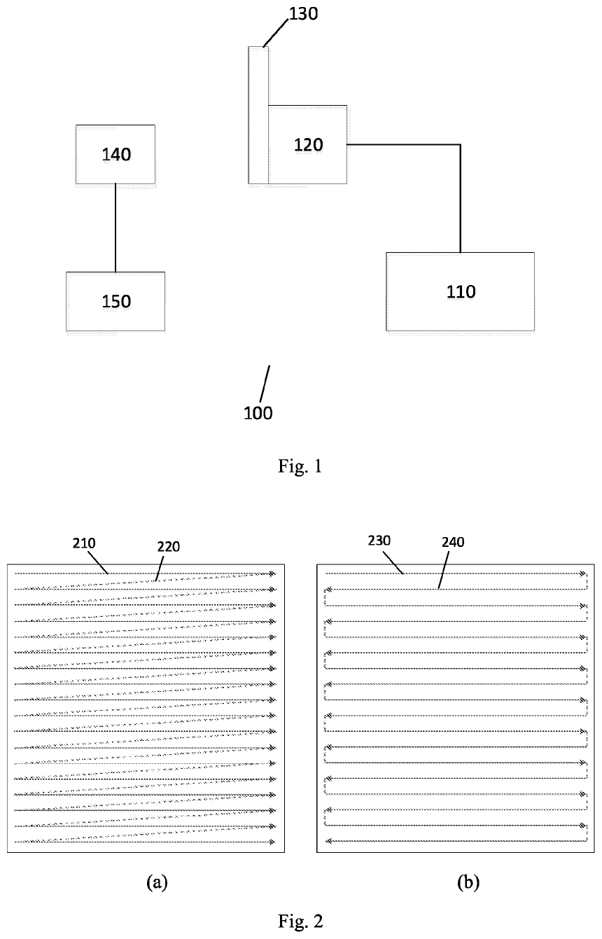

FIG. 1 schematically illustrates a scanning apparatus 100 according to an embodiment of the invention. Examples of laser scanning apparatus 100 are laser scanning microscopy (LSM) and LIDAR, although embodiments of the invention are not limited in this respect. The apparatus 100 comprises a control unit 110 which is arranged to provide a control signal to a scanning unit 120. The scanning unit 120 may comprise electro-mechanical components, such as one or more motors, which control a location within a scene at which a radiation source 130, in use, emits radiation. The radiation may comprise, without limitation, light (visible and non-visible), sound (including ultrasound), electromagnetic (including microwave radiation). For example, a motor of the scanning unit 120 may be arranged to move a laser light source 130 or one or more lenses associated with the source 130 to direct the radiation. The radiation, such as light, is directed from the radiation source 130 to a specific target location within the scene by the scanning unit 120. For each target location, or pixel, a detector 140 outputs a signal where data indicative of the signal is stored in a memory 150 to form image data. The data may be referred to as a pixel value corresponding to the target location within the scene. The control unit 110 controls the scanning unit 120 to scan the radiation across the scene in a plurality of scanning lines as will be explained.

FIG. 2 illustrates examples of unidirectional and bidirectional scanning of a scanning apparatus such as that illustrated in FIG. 1. In unidirectional scanning the scanning unit 120 is controlled to direct the radiation from the radiation source 130 across the scene in scan lines having one direction. That is, although the scanning unit 120 may also move in a second, opposing, direction, pixel values are not stored in the memory during movement in the second direction. The scanning unit 120 may be controlled to scan the radiation across the scene in the first direction along each scan line in a generally continuous movement at a scan speed.

FIG. 2(a) illustrates unidirectional scanning whereby the scanning unit scans radiation in a scanning line 210 of the first direction across the scene whilst the detector 140 provides an output signal associated with each pixel location along the scanning line 210. The scanning unit 120 then returns 220 the radiation source to a location aligned with a start of the scanning line 210, but at a location moved perpendicular to the scanning line, i.e. in a downward direction, before repeating movement along the scanning line 210 but at a vertically displaced location. The path of each scanning line 210 may be assumed to be horizontal but may be inclined in the downward direction along the scan line 210. Thus, it can be appreciated that the scanning unit 120 is arranged to move in a predetermined scan pattern. The scan pattern may be a raster scan pattern, although other scan patterns are known. It will be appreciated that the scanning unit 120 causes a position at which the radiation is directed to move relative to the scene. The scanning unit may move the radiation source 130, focusing apparatus such as one or more lenses, voltage plates etc., or may move the apparatus 100 relative to the scene. In some embodiments the scanning unit 120 may cause a position of an object in the scene to change relative to the radiation source. Furthermore, in some embodiments both a position of the scene and the radiation source may move, such as in push broom airborne systems.

During the predetermined scan pattern, one or both of a position and a direction of movement of the radiation changes with respect to the scene. As noted above, the scanning unit comprises one or more electro-mechanical components responsible for causing the movement such as motors. A control of those electro-mechanical components is in practice limited, for example limited in precision. For example at each time point the actual direction of the radiation will be an approximation to a commanded direction, and the larger the directional displacement the poorer the approximation is expected to be. In particular, velocity and acceleration limits the precision. Practical constraints exist on possible velocity and acceleration which limit the precision. As a result, the image data generated is prone to artefacts as a result of the deficiencies of the control and electro-mechanical components, such as the motor, and crucially the intrinsic measurements (e.g. those reported by the motor controller) cannot be completely relied upon. In embodiments of the invention extrinsic information i.e. measurements from the scene are used to improve intrinsic information i.e. relating to the position of the radiation source, as will be explained.

A response of the detector 140 at each pixel location along the scan line 210 is stored in the memory 150 as a pixel value for that location to form image data. Thus, the image data is formed by a plurality of lines of pixel values, wherein each line of comprises a plurality of pixel values at respective locations along the scan line 210. Each pixel value may be displaced at equal distances along the scan line 210.

An image of the scene, including one or more objects in the scene, may be generated from the image data stored in the memory 150. A display may be controlled to display a representation of the image data, such as with a colour or brightness representative of the value of each respective pixel.

FIG. 2(b) illustrates bi-direction scanning where the scanning unit 120 is controlled to scan the radiation across the scene in two, generally opposed, directions whilst pixel data is recorded. The scanning unit 120 is controlled to scan the radiation along a first scan line 230 in a first direction. Instead of returning the radiation to a position aligned with a start of the first scan line 230 before scanning along a second scan line 240, as in uni-directional scanning, the scanning unit 120 is controlled to scan the radiation along the second scan line 240 in a second direction whilst pixel values corresponding to an output of the detector 140 are stored in the memory 150. Bidirectional scanning decreases the overall acquisition time of the image data by moving from the end of the first scan line 230 directly to the end of the next line 240 and from the end to the beginning of the second scan line 240.

It can therefore be appreciated that bi-directional scanning performs faster scanning of the scene. The scan speed i.e. the speed of movement of the scanning unit 120 may also be controlled by the control unit 110.

Although bidirectional line scanning, such as in FIG. 2(b) is faster than unidirectional line scanning as in FIG. 2(a), it poses a greater challenge since it is difficult to maintain spatial consistency of image data as the neighbouring scan lines 230, 240 are scanned in opposite directions. The spatial image inconsistency may be caused by the varying speed of the first, forward 230, and second, backward 240, scanning direction by the scan unit 120. The speed of scanning in the first and second directions 230, 240 may not be a symmetric function. A control function employed by the control unit 110 to control the scanning unit 120 may involve an acceleration that is typically different from subsequent deceleration. Such spatial image inconsistency is particularly apparent when the scanning unit 120 acceleration (or deceleration) approach a maximum supported by the apparatus 100. In other words, the spatial inconsistency may increase with increasing scan speed of the scanning unit 120.

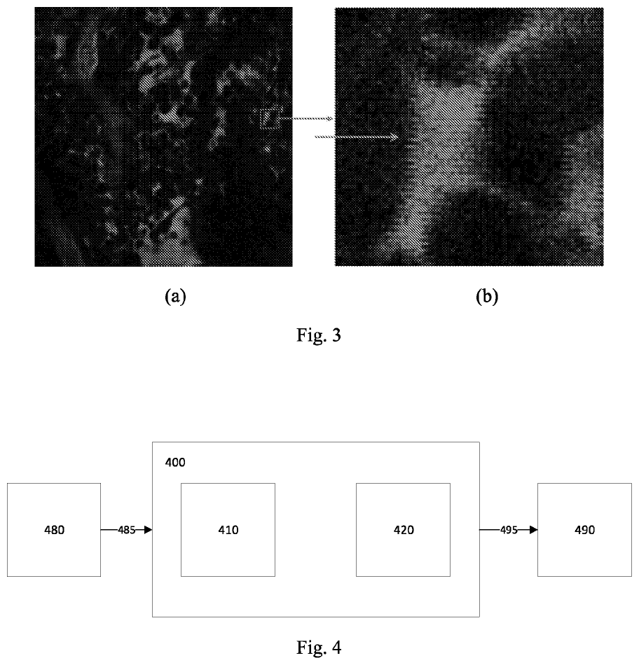

The control function of the control unit 110 may be, for example, a bang-coast-bang control function. The bang-coast-bang control function may comprise an initial acceleration, which may be constant, followed by an intended-constant velocity (coast), followed by a deceleration, which may be constant. Whilst the coast is intended to be constant, in practice it has been found by the present inventors that often the coast-phase varies in velocity, sometimes curving between acceleration and deacceleration, as shown in FIGS. 7 and 8. Assuming such a control function, a difference between the forward and backward bidirectional line scanning equates to a difference between the acceleration, deceleration and/or differences in velocity. These are different physical processes with different values which may be different. Furthermore, as scanning speed is controlled to increase i.e. for the apparatus to scan more rapidly, these problems are exacerbated. As acceleration and deacceleration increase, control may become more difficult and artefacts, including noise, may increase. Therefore, the spatial image inconsistency may severely deteriorate the quality of acquired images by introducing geometric distortions, such as a jaggedness artefact, and thus significantly limit, in practice, the use of fast, high-resolution scanning imaging techniques for the faster bi-directional scanning mode. A typical example of the jaggedness artefact in a bidirectional line scanning is presented in FIG. 3. As is readily apparent, the geometry of an object in the scene is severely distorted by the jaggedness artefacts, as indicated with arrows, leading also to the reduced contrast and poorer signal-to-noise ratio in the acquired images. Such image quality degradation may become a major limiting factor for quantitative image analysis, particularly although not exclusively at higher spatial resolutions.

FIG. 4 illustrates an apparatus 400 according to an embodiment of the invention which, in use, determines displacement information. The apparatus 400 may be arranged to process image data. In particular, the apparatus 400 may determine displacement information for the image data. The displacement information may relate to a displacement of lines of image data in an axis parallel to a scanning direction of the image data, as will be explained. In some embodiments, the apparatus may filter the image data.

The apparatus 400 comprises a displacement module 410 and a filtering module 420. The apparatus is arranged to receive image data 485 from a scanning apparatus 480. The scanning apparatus 480 may be such as that described above with reference to FIG. 1. The image data 485 forms an image I as will be explained. The apparatus 400 may be an image processing unit or module. The apparatus 400 may be implemented in hardware or may be one or more modules formed by computer-readable instructions stored in a data storage medium and which are executed by one or more electronic processing devices. The displacement module 410 is arranged to determine a displacement between pixels in adjacent scanning lines as will be explained. The filtering module, which may be omitted in some embodiments, may apply one or more filtering operations to the image data. Processed image data 495 is output by the apparatus 400. The processed image data 495 may be output to a display device 490 for display thereon. Connections between the apparatus 400 and one or both of the scanning apparatus 480 and display device 490 may be via one or more computer networks such as the internet. That is, whilst in some embodiments the apparatus 400 may be physically associated with the scanning apparatus 480, in other embodiments the apparatus 400 may be implemented as cloud-based software which receives the image data 485 over the internet and provides the processed image data 495 over the internet to the display device 490. The display device 490 may be associated with the scanning apparatus 480.

The image I represented by the image data 485 may be formed from sequentially acquired scan lines iⁿ where n=1 . . . N scan lines in the image. Thus, for bi-directional scanning, an odd scan line i¹ is scanned in the first direction and an even scan line i² is scanned in the second direction. However, artefacts in the image data may arise from displacement between pairs of lines such as i¹ and i² as explained above.

Embodiments of the invention improve geometrical image consistency via compensation for local displacements which may be caused by the variable speed of scanning by the scanning apparatus 100, 480 during bidirectional scan line acquisition.

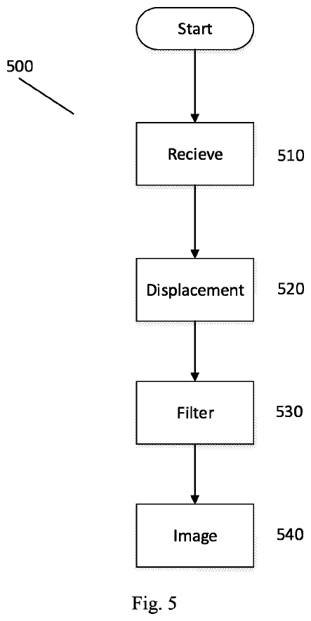

FIG. 5 illustrates a method 500 of determining displacement information according to an embodiment of the invention. The method 500 may be implemented by the apparatus 400 illustrated in FIG. 4. In some embodiments the method 500 may be implemented by a computer or electronic processing device.

The method 500 comprises a step 510 of receiving image data 485. As described above, the image data 485 may represent an image I and be received from a scanning apparatus 100, 480 over a data communication channel which may be provided by one or more computer networks.

The method 500 comprises a step 520 of determining displacement information for the image data 485. The displacement information relates to a displacement of pixel values in a direction parallel to the scanning direction of the scan lines of the image data 485.

The displacement information may be determined for each pixel. That is, a respective displacement value may be determined for each pixel along a scan line, as will be explained.

A local displacement u between sequentially acquired lines iⁿ that constitute the image I is determined by embodiments of the invention. For each pair of lines (scanned forwards and backwards) i.e. i=1, 2 an estimation of the local displacement u may be defined in embodiments of the invention as the optimization of a generic cost function ϵ(u) as follows:

$$\hat{u} = arg {min}_{u} ( ϵ ( u ) = sim ( u ) + α reg ( u ) ) \qquad Eqn . 1$$

where sim denotes a similarity term between the lines i, reg denotes a regularization (smoothness) term of the local displacement u, and α is a weighting parameter.

In some embodiments, it is assumed that each backward acquired line iⁿ is similar to the two nearest or adjacent forward acquired lines, iⁿ⁻¹ and iⁿ⁺¹. Therefore, in some embodiments, a sum of squared differences (SSD) is used as the similarity measure sim. In some embodiments, sim may be as follows:

$$s i m ( u ) = {\int }_{x ∈ Ω} ( {\sum }_{n = 2 , 4 , 6 , …}^{N} {( {i}_{x}^{n - 1} - {i}_{x}^{n} ( {u}_{x} ) )}^{2} + {\sum }_{n = 2 , 4 , ó , … ,}^{N - 1} {( {i}_{x}^{n + 1} - {i}_{x}^{n} ( {u}_{x} ) )}^{2} ) dx \qquad Eqn . 2$$

wherein u is displacement, x is a spatial position of ith pixel data, Ω is a total number of pixels in pixels in the image data and Nis a total number of lines of pixel data in the image data and n identifies one of the N lines of pixel data.

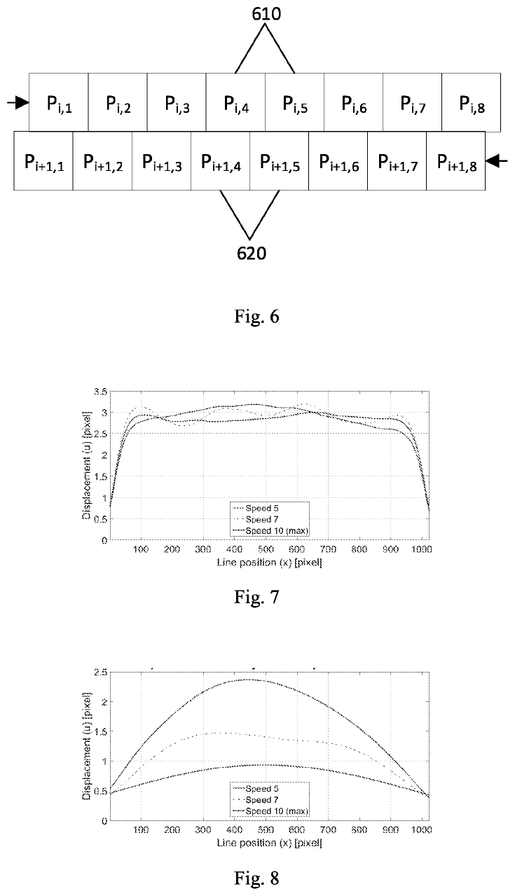

Referring to FIG. 6, two adjacent scan lines iⁿ, iⁿ⁺¹ are shown comprising a plurality of pixels 1 . . . 8. Although each scan line is illustrated as comprising 8 pixels it will be appreciated that this is merely illustrative. A first scan line, representing first pixel data corresponding to movement of the scanning apparatus in a first direction, comprises pixels 610 whilst a second scan line, representing second pixel data corresponding to movement of the scanning apparatus in a second direction, comprises pixels 620, only two of which in each line are indicated with reference numerals for clarity. A direction of scanning of the scan lines is also shown in FIG. 6. A subsequent scan line (iⁿ⁺²) would be understood to represent third pixel data.

As can be appreciated from the above similarity equation, a displacement between a pixel x in adjacent scan lines (n−1 and n) and (n+1 and n) is determined. Owing to the integral in the above similarity equation the outer brackets cause a determination of displacement values for each pixel (1 . . . 8) in step 520 over all scan lines (n=2 . . . N) of the image I, whilst the inner brackets consider one line of pixel values i. Thus, effectively, the displacement information is determined in some embodiments as an average value for pixels of alternate scan lines. It will be appreciated that in other embodiments, respective displacement values may be calculated for each scan line. An advantage of considering all scan lines in the image may rise when the image relates to a phantom. Tests have been conducted using embodiments of the invention with a heterogeneous phantom.

In some embodiments, the estimated displacement u causing the jaggedness artefact is determined as a locally smooth function (that has continuous derivatives). A local diffusion model may be used as reg to regularise the displacement. In some embodiments reg may be:

reg(u)=∫_{x∈Ω}∥∇uₓ∥²dx Eqn. 3

Step 520 comprises optimising the cost function given by Eqn. 1. The cost function may be optimised by a variety of methods available to the skilled person. In some embodiments, the optimization of the cost function given by Eqn. 1 is performed using an iterative efficient second-order minimization (ESM) Gauss-Newton scheme presented by Vercauteren et al. (2006).

As a result of step 520, in some embodiments, a plurality of displacement values each relating to one pixel of the scan lines forming the image I is determined. The plurality of displacement values may be an array of displacement values, such as:

U=[U₁,U₂, . . . ,U_{N}]

By applying the displacement value to each respective pixel in alternate rows of the image I a location of the pixels may be adjusted to reduce the artefacts arising from the displacement i.e. the jaggedness of the image data.

In some embodiments step 520 may comprise comparing the displacement information with one or more displacement thresholds. The one or more thresholds may be indicative of whether the scanning apparatus requires attention, such as remedial attention i.e. servicing, which may reduce the displacement of pixel data. In some embodiments, dependent on a result of the comparison, the method comprises in step 520 outputting an indication to a user. The output may be one or both of visual and audible to notify the user that the displacement of pixel data exceeds the one or more thresholds. The output may signify that the user should provide attention, such as servicing, to the apparatus.

Step 530 may comprise applying a filtering operation to the image data. In some embodiments a locally weighted filtering is performed in step 530 for a single bidirectional acquisition, which may be applied after performing step 520 to determine the displacement information, to increase the SNR, and thus improve the final quality of the reconstructed image. In some embodiments, a guided image self-filtering (GIF) operation is performed in step 530. Such a GIF operation is described in He, Kaiming, Jian Sun, and Xiaoou Tang. “Guided image filtering.” IEEE transactions on pattern analysis and machine intelligence 35.6 (2013): 1397-1409, which is herein incorporated by reference.

The GIF employs a locally weighted averaging filter, which is computationally advantageous since its computational cost is independent of the filter size. The GIF is defined as follows:

Oₓ=GIF(Iₓ)=Σ_{yεω}_{ₖ}W_{x,y}(G)I_{y} Eqn. 4

where O is a filtering output, I is an input image, G is the guidance image, ωₖ is a local window centred at pixel y.

$${W}_{x , y} ( G ) = \frac{1}{\vert ω \vert} {\sum }_{z ∈ ω} ( 1 + \frac{( {G}_{x} - {μ}_{z} ) ( {G}_{y} - {μ}_{z} )}{{σ}_{z}^{2} + η} ) \qquad Eqn . 5$$

where μ_{z} and σ_{z} are the mean and variance of image G in ωₖ respectively, |ω| is the number of pixels in ω, and η is a regularization parameter, which may be supplied by a user. The filtering algorithm exploits information provided in the input image I to increase the SNR in the output image O. Advantageously the filtering algorithm does not involve repeated line acquisition, so it does not increase the overall acquisition time.

FIGS. 7 and 8 illustrate displacement information u, in this example in units of pixels, against pixel position x (line position) at different line scan speeds for two different scanning apparatus, in this case models of microscope. As can be appreciated, for each microscope as the scanning speed increases the displacement increases. It can also be noted that for some scanning apparatus the amount of displacement is not constant along the scan line. As shown in FIG. 8 displacement may increase for some positions along the scan line.

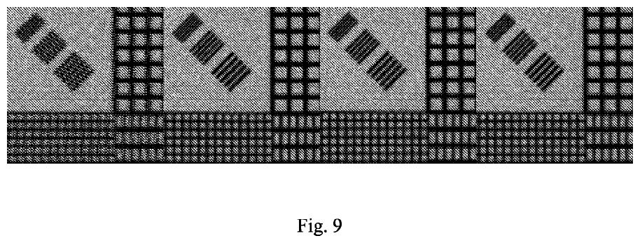

FIG. 9 shows four images produced using different approaches, which are from left to right: bidirectional without displacement correction, unidirectional, bidirectional with displacement correction provided by a manufacturer of the scanning apparatus, and bidirectional with displacement correction according to an embodiment of the invention. As can be appreciated, the bidirectional with displacement correction according to an embodiment of the invention shows improvement in image quality, particularly a reduction in jaggedness.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A computer-implemented method of determining displacement information, comprising:
receiving image data comprising first pixel data corresponding to movement of a scanning apparatus, with respect to at least one object, in a first direction and a second pixel data corresponding to movement of the scanning apparatus in a second direction; and
determining displacement information indicative of a displacement of at least a portion of the second pixel data with respect to the first pixel data by minimising a cost function indicative of a similarity between the first and second pixel data.

2. The method of claim 1, wherein:
the receiving comprises receiving third pixel data indicative of movement of the scanning apparatus in a third direction
determining the displacement information comprises optimising the cost function indicative of the similarity between the first, second and third pixel data.

3. The method of claim 2, wherein the cost function comprises a first component indicative of the similarity between the first and second pixel data and a second component indicative of the similarity between the second and third pixel data.

4. The method of a claim 1, comprising determining respective displacement information for each of a plurality of pixels of the second pixel data.

5. The method of claim 4, wherein the respective displacement information for each of the plurality of pixels is determined with respect to further pixel data corresponding to movement of the scanning apparatus in the second direction.

6. The method of claim 5, wherein the displacement information is determined as average displacement information for pixel data corresponding to movement of the scanning apparatus in the second direction.

7. The method of claim 1, wherein the cost function is:
$$si m ( u ) = {\int }_{x ∈ Ω} ( {\sum }_{n = 2 , 4 , 6 , …}^{N} {( {i}_{x}^{n - 1} - {i}_{x}^{n} ( u ) )}^{2} + {\sum }_{n = 2 , 4 , ó , …}^{N - 1} {( {i}_{x}^{n + 1} - {i}_{x}^{n} ( u ) )}^{2} ) dx$$
wherein u is displacement, x is a spatial position of ith pixel data, Ω is a total number of pixels in pixels in the image data and N is a total number of lines of pixel data in the image data.

8. The method of claim 1, wherein the cost function comprises a regularisation function indicative of a regularisation of displacement information for the image data.

9. The method of claim 8, wherein the regularisation function is a smooth regularisation model

10. The method of claim 9, wherein the smooth regularisation model is a local diffusion model.

11. The method of claim 8, wherein the regularisation function is:
reg(u)=∫_{x∈Ω}∥∇uₓ∥²dx
wherein u is displacement, x is a spatial position of ith pixel data and Ω is a total number of pixels in pixels in the image data.

12. The method of claim 1, wherein the cost function is a function indicative of the similarity between the first and second pixel data.

13. The method of claim 12, wherein the cost function is a sum of squared differences.

14. The method of claim 1, wherein the first pixel data corresponds to a first line of pixel data and the second pixel data corresponds to a second line of pixel data.

15. The method of claim 14, wherein the image data comprises at least four lines of pixel data and the determining the displacement information comprises determining the displacement information for alternate lines of pixel data.

16. (canceled)

17. The method of claim 1, wherein the displacement information is indicative of the displacement of at least a portion of the second pixel data with respect to the first pixel data in an axis of one of the first and second directions.

18. The method of claim 1, wherein the first direction is generally opposed to the second direction and the displacement information is indicative of the displacement of at least a portion of the second pixel data with respect to the first pixel data in the first direction with respect to the second direction.

19. The method of claim 1, wherein the cost function is optimised by an iterative process.

20. The method of claim 1, wherein the cost function is optimised by a discrete process.

21. The method of claim 1, comprising comparing the displacement information with one or more displacement thresholds.

22. The method of claim 21, comprising outputting an indication to a user in dependence on the comparison.

23. A computer-readable data storage medium tangibly storing computer software which, when executed, is arranged to perform a method according to claim 1.

24. (canceled)

25. (canceled)

26. An apparatus for determining displacement information, comprising:
an input for receiving image data comprising first pixel data corresponding to movement of a scanning apparatus, with respect to at least one object, in a first direction and a second pixel data corresponding to movement of the scanning apparatus in a second direction;
a displacement module arranged to determine displacement information indicative of a displacement of at least a portion of the second pixel data with respect to the first pixel data by minimising a cost function indicative of a similarity between the first and second pixel data, wherein the displacement module is arranged to displace the second pixel data with respect to the first pixel data in dependence on the determined displacement information to generate processed image data; and
an output for outputting the processed image data.

27. The apparatus of claim 26, comprising a filtering module for applying a filtering operation to the processed image data.
